(19) United States
(12) Patent Application Publication
(10) Pub. No.: US 2024/0310405 A1
(43) Pub. Date: Sep. 19, 2024

(54) An Accelerometer for Determining Acceleration of an Object and a Method Thereof

(71) Applicant: Tilak Srinivasan, Bangalore, Karnataka (IN)

(72) Inventor: Tilak Srinivasan, Bangalore, Karnataka (IN)

(21) Appl. No.: 18/576,232

(22) PCT Filed: Jul. 5, 2022
(86) PCT No.: PCT/IB2022/056216

§ 371 Date: Jan. 3, 2024

(30) Foreign Application Priority Data
Jul. 5, 2021 (IN) 202141027389

(51) Int. Cl. G01P 15/093

(52) U.S. Cl. CPC G01P 15/093

(57) ABSTRACT

The present disclosure includes an accelerometer for determining acceleration of an object. The accelerometer includes an enclosure and an armature. The armature includes a hub and a plurality of arms, each defined with at least one roller at a free end. The roller contacts an inner surface of the enclosure, and at least one arm has an opaque roller. The armature displaces about at least one axis in response to acceleration of the object, and displaces the at least one arm to a predefined angular position between first and second positions. Sensors are embedded on an outer surface of the enclosure, and at least one light source illuminates the accelerometer such that opaque roller blocks light from reaching at least one sensor at the predefined angular position, indicative of the acceleration of the object.

### FIELD

The present disclosure generally relates to the field of measurements and metrology. Particularly, but not exclusively, the present disclosure relates to measurement of acceleration of an object. Further, embodiments of the present disclosure disclose an accelerometer for determining acceleration of an object and a method for determining the acceleration with the accelerometer.

### BACKGROUND

Measurement is one of the fundamental processes performed to assess quantitative characteristics of a physical quantity. Measurement of physical quantities such as length, velocity, acceleration, displacement, elevation, inclination, etc., is performed to investigate certain physical conditions. For example, investigation of elevation, inclination, etc., is performed in geological studies, while determination of acceleration, velocity is of particular interest to engineers, physicists, space scientists, and so on. Determination of acceleration i.e., rate at which velocity of a moving object changes, is of particular interest in assessing certain vibrational characteristics of objects, such as machines, structures, vehicles, etc. Earlier mechanical systems were used for such determination, but with the advancement of sensor technology, sensors such as accelerometers of different types are used to determine accelerations.

One of the extensive types of accelerometers used is a piezoelectric based accelerometer constructed of a piezoelectric material. When piezoelectric accelerometer is coupled with an object whose vibration or acceleration is to be measured, the piezoelectric material in the accelerometer produces electric current in response to the force exerted by the vibrating object. The magnitude of electric current produced gives direct indication of acceleration of the vibrating object. Such accelerometers are widely used in seismology to sense seismic energy, and in Structural Health Monitoring which involves real-time determination and monitoring of health of a structure, for example, a bridge, a tower, a skyscraper, etc., which are periodically subjected to dynamic loads and vibrations. Apart from piezoelectric accelerometer, one can witness other forms of accelerometers in day-to-day life. For example, smartphones are equipped with pedometers that use accelerometers to detect the acceleration caused when a user takes a step. In such devices, a single accelerometer is used to generate accelerometer data that can be processed on the device itself or relayed to another device for processing through communication modules. In addition, with the advancement of VR [virtual reality] and AR [augmented reality] technologies, most of the VR/AR based devices like wearable gadgets employ navigation devices like direction sensors and acceleration detecting sensors. Such sensors take part in altering images and/or sounds in relation to the direction or acceleration of the user's head to provide a realistic experience in a virtual environment.

Although above stated accelerometers can be readily implemented and used on existing devices, they are associated with certain drawbacks such as sophistications associated with their construction, cost, accessibility or ease with which they can be used, possibility of coupling them with any generic object whose acceleration is to be determined, requirement of communication/transmission channels or lines, and so on.

Present disclosure is directed to overcome one or more limitations stated above or any other limitations associated with the existing arts.

### SUMMARY

One or more shortcomings of the existing art are overcome by the accelerometer as disclosed in the present disclosure and additional advantages are provided through the accelerometer. Additional features and advantages are realized through the techniques of the present disclosure. Other embodiments and aspects of the disclosure are described in detail herein and are considered a part of the claimed disclosure.

In one non-limiting embodiment of the present disclosure, an accelerometer for determining acceleration of an object is disclosed. The accelerometer includes an enclosure and an armature movably disposed inside the enclosure. The armature includes a hub and a plurality of arms extending from the hub, where each of the plurality of arms is defined with at least one roller at a free end. The at least one roller is configured to contact an inner surface of the enclosure, such that at least one arm of the plurality of arms is defined with an opaque roller. Further, the armature is configured to displace within the enclosure about at least one axis in response to acceleration imparted on the object, and displaces the at least one arm of the plurality of arms to a predefined angular position between a first position and a second position. A plurality of sensors is embedded on at least a portion of an outer surface of the enclosure. Also, at least one light source is configured to illuminate the accelerometer such that the opaque roller is configured to block light from reaching at least one sensor of the plurality of sensors corresponding to the predefined angular position of the at least one arm of the plurality of arms, indicative of the acceleration of the object.

In an embodiment, the enclosure contacts the object for determination of the acceleration. Further, the enclosure is accommodated in a transparent housing.

In an embodiment, the plurality of arms includes at least three pairs of arms, each pair of arms protruding from the hub towards the inner surface of the enclosure along a coordinate axis. Further, each of the pairs of arms extends orthogonally from the hub relative to other pairs of arms.

In an embodiment, the enclosure is a transparent enclosure of spherical shape configured to allow passage of light onto the plurality of sensors. Further, the plurality of sensors is embedded on outside of at least one of a lower hemispherical surface, an upper hemispherical surface, a right hemispherical surface, and a left hemispherical surface, of the spherical shaped enclosure.

In an embodiment, the at least one arm remains at a home position when no acceleration is imparted on the object, and a first position corresponds to −90 degree position of the at least one arm of the plurality of arms. Further, a second position corresponds to +90 degree position of the at least one arm of the plurality of arms. The home position lies between the first position and the second position.

In an embodiment, a light source is positioned adjacent to the enclosure to illuminate the plurality of sensors. In another embodiment, the light source is positioned at a center of the hub.

In another non-limiting embodiment of the present disclosure, a method of determining acceleration of an object is disclosed. The method includes positioning the object in contact with an accelerometer. The accelerometer includes an enclosure and an armature movably disposed inside the enclosure. The armature includes a hub and a plurality of arms extending from the hub, where each of the plurality of arms is defined with at least one roller at a free end. The at least one roller is configured to contact an inner surface of the enclosure, such that at least one arm of the plurality of arms is defined with an opaque roller. Further, the armature is configured to displace within the enclosure about at least one axis in response to acceleration imparted on the object, and displaces the at least one arm of the plurality of arms to a predefined angular position between a first position and a second position. A plurality of sensors is embedded on at least a portion of an outer surface of the enclosure. The method also includes positioning at least one light source adjacent to the accelerometer, the at least one light source configured to illuminate the accelerometer such that the opaque roller is configured to block light from reaching at least one sensor of the plurality of sensors corresponding to the predefined angular position of the at least one arm. Further, the method includes receiving a signal from the at least one sensor corresponding to the predefined angular position of the at least one arm, the signal indicative of the acceleration of the object.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

In an embodiment, movable components in the accelerometer such as the enclosure, and the rollers connected to the arms and contacting the inner surface of the enclosure are made of a material that offers very low co-efficient of friction. Further, the enclosure, the hub, the rollers and the arm are made of transparent material and allow light to pass through. In other words, all the components of the accelerometer except the opaque roller in the accelerometer are made of transparent material. In an embodiment, each of the hub, the bearing the arm and the roller is made of light weight material. In an embodiment, all the components of the accelerometer are made of light weight material.

### BRIEF DESCRIPTION OF THE DRAWINGS

The novel features and characteristics of the disclosure are set forth in the appended description. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a sectional front view of the accelerometer, in accordance with an embodiment of the present disclosure;

FIG. 2 illustrates a perspective view of an armature of the accelerometer shown in FIG. 1;

FIG. 3 illustrates front view of the accelerometer of FIG. 1 depicting sectional view of the armature considered along section S-S in FIG. 2, along with a plurality of sensors embedded on the enclosure; and

FIG. 4 illustrates a schematic view of a light source illuminating the accelerometer shown in FIG. 1, according to an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the description of the disclosure. It should also be realized by those skilled in the art that such equivalent methods do not depart from the scope of the disclosure. The novel features which are believed to be characteristic of the disclosure, as to method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In the present disclosure, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover non-exclusive inclusions, such that a device, system or a method that comprises a list of acts does not include only those acts but may include other acts not expressly listed or inherent to such a device, system or a method. In other words, one or more acts in the device, the system or the method preceded by “comprises . . . a” does not, without more constraints, preclude the existence of other acts or additional acts in the device, the system or the method.

It is to be noted that a person skilled in the art would be motivated from the present disclosure and modify configuration of an accelerometer. However, such modifications should be construed within the scope of the instant disclosure. Accordingly, the drawings show only those specific details that are pertinent to understand the embodiments of the present disclosure so as not to obscure the disclosure with details that will be readily apparent to those of ordinary skill in the art having benefit of the description herein.

Embodiments of the present disclosure disclose an accelerometer for determining acceleration of an object. The accelerometer includes an enclosure and an armature movably disposed inside the enclosure, such that the armature may displace about coordinate axes when imparted with acceleration. The armature includes a hub and a plurality of arms extending from the hub, where each of the plurality of arms is defined with at least one roller at a free end. The at least one roller is configured to contact an inner surface of the enclosure, such that at least one arm of the plurality of arms is defined with an opaque roller. Each roller may roll against the inner surface of the enclosure and assist in rolling motion of the arms during displacement of the armature. In an embodiment, the plurality of arms includes at least three pairs of arms, each pair of arms protruding from the hub towards the inner surface of the enclosure along a coordinate axis. Each of the pairs of arms extends orthogonally from the hub relative to other pairs of arms. In an embodiment, the at least one arm remains at a home position when no acceleration is imparted on the object.

Further, the armature that gets displaced within the enclosure in response to acceleration imparted on the object displaces the at least one arm to a predefined angular position between a first position and a second position. In an embodiment, the first position corresponds to −90 degree position of the at least one arm of the plurality of arms, and the second position corresponds to +90 degree position of the at least one arm of the plurality of arms. The home position may lie between the first position and the second position. In other words, the home position may be the zero position which is equidistant from the first position [−90 degree position] and the second position [+90 degree position], and lying between the first position [−90 degree position] and the second position [+90 degree position]. The enclosure may also be equipped with a plurality of sensors, each embedded on an outer surface of the enclosure in a predefined pattern or an array. The plurality of sensors may take part in detecting the position of the at least one arm as a part of determination/measurement of the acceleration. In addition to sensors, at least one light source may be positioned adjacent to the enclosure so as to illuminate the accelerometer. Upon illumination, the opaque roller held by the at least one arm in the predefined angular position may block light from reaching at least one sensor of the plurality of sensors. The position of the at least one sensor may correspond to or align with the predefined angular position of the at least one arm of the plurality of arms, such that the at least one sensor may not receive incident light from the at least one light source due to opacity of the at least one roller. In an embodiment, the enclosure may contact the object which is accelerated. Also, the enclosure may be accommodated in a transparent housing.

In an embodiment, the enclosure is a transparent enclosure of spherical shape configured to allow passage of light onto the plurality of sensors. The spherical shape of the enclosure may allow the plurality of sensors to be embedded on a lower hemispherical surface of the spherical shaped enclosure. In an embodiment, a light source may be positioned adjacent to the enclosure to illuminate the plurality of sensors.

Embodiments of the present disclosure also disclose a method of determining acceleration of an object. The method includes positioning the object in contact with an accelerometer. The accelerometer includes an enclosure and an armature movably disposed inside the enclosure, whose details have been explained in the above paragraphs. The method also includes positioning at least one light source adjacent to the accelerometer, the at least one light source configured to illuminate the accelerometer such that the opaque roller is configured to block light from reaching at least one sensor of the plurality of sensors corresponding to the predefined angular position of the at least one arm. Further, the method includes receiving a signal from the at least one sensor corresponding to the predefined angular position of the at least one arm, the signal indicative of the acceleration of the object.

The present disclosure is explained with the help of figures. However, such exemplary embodiments should not be construed as limitations of the present disclosure since the accelerometer disclosed may be used or employed in or with any of the instruments, equipment, measuring devices, systems, set ups, tools, assemblies and machines. A person skilled in the art may envisage various such embodiments without deviating from scope of the present disclosure

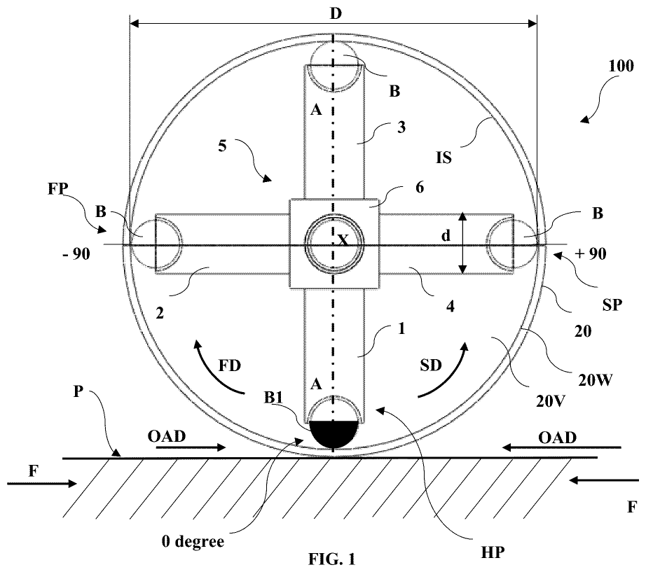

FIG. 1 is an exemplary embodiment of the present disclosure which illustrates a sectional view of an accelerometer (100) intended to determine acceleration of an object (P). The accelerometer (100) includes an enclosure (20), typically a hollow body designed to enclose components of the accelerometer (100). The enclosure (20) may be made of a composite material or any other synthetic material such as glass, plastic, acrylic, etc., which is transparent in nature for allowing passage of light. In an embodiment, the enclosure (20) is made of a transparent material including, but not limited to composite polymers like nylon nanofibers, polyacrylonitrile (PAN), and the like, embedded into an epoxy matrix. In another embodiment, the enclosure (20) may be spherical resembling a transparent ball, and having a diameter ‘D’ as shown. Inner surface (IS) and interior volume (20V) bound by the wall (20W) of the enclosure (20) are depicted in FIG. 1.

Inside of the enclosure (20) comprises of an armature (5) formed of a plurality of arms (1,2,3,4,7,8). In an embodiment, the armature (5) may be freely positioned inside the enclosure (20) such that the armature (5) may exhibit angular displacement about any of the principal axes, which will be explained later. The object (P) which is accelerated and whose acceleration needs to be determined may be placed in contact with the enclosure (20). For example, as shown in FIG. 1, the object (P) may support the enclosure (20) above it or may maintain contact with the enclosure (20) from any desired direction and orientation. In an embodiment, the object (P) may be coupled to the accelerometer (100). Once the object (P) is excited or imparted with a force or a displacement, the object (P) contacting the accelerometer (100) may transmit the force or the motion to the accelerometer (100). In response to transmission of force or motion, the accelerometer (100) may produce displacement of the armature (5). In other words, the armature (5) produces reaction in the form of displacement when the object (P) contacting the accelerometer (100) is accelerated. Depending on the position and orientation of the object (P) relative to the accelerometer (100), the armature (5) may undergo displacement or oscillation with reference to any of the principal axes. The exemplary/illustrative direction(s) in which the object (P) may be accelerated is depicted by arrows referenced by reference symbol (OAD). In an embodiment, the inner surface (IS) of the enclosure (20) may maintain continuous contact with each of the plurality of arms (1,2,3,4,7,8) of the armature (5) via rollers (B, B1), with each roller having a radius ‘R’. In an embodiment, the inner surface (IS) of the enclosure (20) may be manufactured of a scratch/indent/abrasion resistant material such that the passage of light is unaffected due to optical anomalies, like interference, diffraction, adverse refraction, reflection, etc.

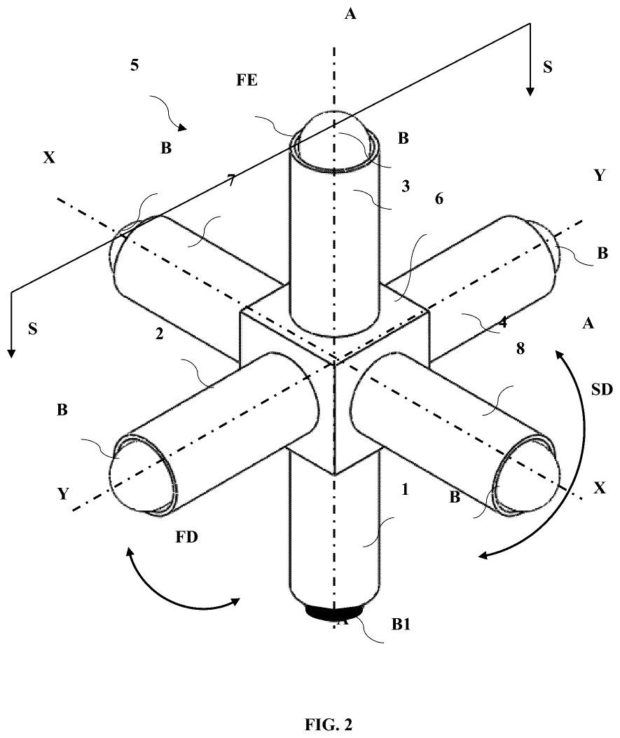

Now reference is made to FIG. 2 which is an exemplary embodiment illustrating a perspective view of the armature (5). Reference is also made to FIG. 1 in conjunction with FIG. 2 to describe constructional features of the armature (5). The armature (5) may include a hub (6) from which the plurality of arms (1,2,3,4,7,8) may emerge in radial directions, as can be seen in FIGS. 1 and 2. In an embodiment, the plurality of arms (1,2,3,4,7,8) may be categorized into pairs of arms, with arms in each pair extending from either side of the hub (6) along a common axis. For example, the arms (1,3) may constitute a pair of arms extending along axis A-A, while the arms (2,4) constitute another pair of arms extending along common axis Y-Y, and the arms (7,8) constitute yet another pair of arms extending along the common axis X-X. In an embodiment, each of the pair of arms extends orthogonally relative to other pairs of arms such that one arm in a pair of arms may be angularly spaced apart at 90 degrees from adjacent arms in a different pair of arms in the three-dimensional space.

In an embodiment, each of the plurality of arms (1,2,3,4,7,8) is made of a lightweight material, preferably a lightweight composite material, including but not limited to nylon nanofibers, polyacrylonitrile and so on. The choice of lightweight materials for the plurality of arms (1,2,3,4,7,8) is to improve sensitivity of the armature (5) even to the slightest of accelerations acting on the object (P). In an embodiment, the plurality of arms (1,2,3,4,7,8) may be transparent. Although three pairs of arms are depicted in drawings, the armature (5) may include two or more than three pairs of arms depending on the requirement. When an acceleration is imparted on the object (P) in a linear direction indicated by OAD, say towards left, the armature (5) may exhibit angular displacement clockwise towards first position (FP), indicated by direction (FD). Once the acceleration becomes zero, the armature (5) may return to its original equilibrium position.

The configuration of the armature (5) may be such that the hub (6) may be movably disposed inside the enclosure (20), enabling it to freely move or displace about all three principal axes. The displacements may be rolling movement about axis X-X, pitching movement about axis Y-Y and yaw movement about axis A-A. FIG. 1 illustrates a two-dimensional view which should not be considered as a limitation, since the armature (5) can have all three angular degrees of freedom inside the enclosure (20) about axes X-X, Y-Y and A-A. Further, each arm of the plurality of arms (1,2,3,4,7,8) may have same length, and same cross-sectional dimension, for example, diameter ‘d’. Consequently, all the arms (1,2,3,4,7,8) may have equal weight provided that they are manufactured of a material having same material density. This allows the armature (5) to undergo displacement equally in all three directions without any bias. In an embodiment, a free end (FE) of each of the arms (1,2,3,4,7,8) opposite to the hub (6) may be defined with rollers (B, B1). The rollers (B, B1) may be seated in provisions like sockets provided at the free end (FE). In an embodiment, the rollers (B, B1) may be bearing elements like the ball bearings, which form a ball and socket joint with the provisions or sockets in the free end (FE). The material for rollers (B, B1) may be selected from polymeric group like acrylic bearings, Polyvinyl chloride (PVC) bearings, or any other synthetic material.

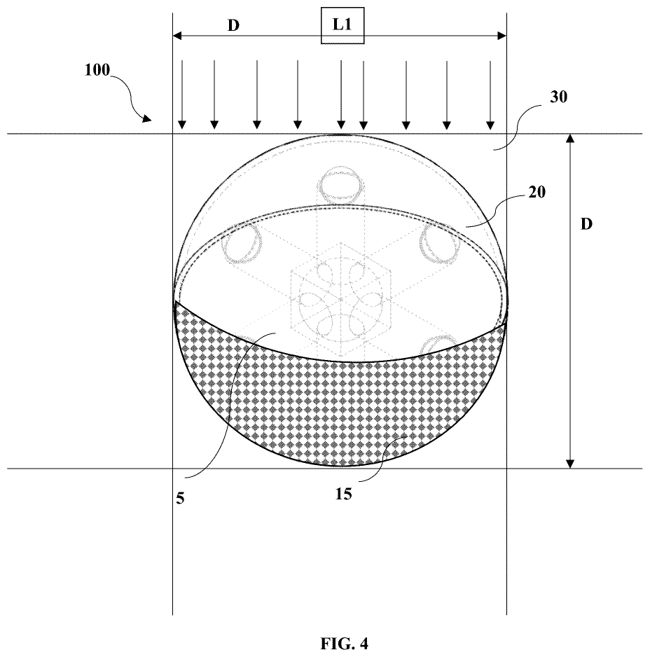

The dimensions of the rollers (B, B1) may be such that, when they are seated onto the free end (FE) of each arm, each roller (B, B1) may contact the inner surface (IS) of the enclosure (20), as depicted in FIG. 1. This configuration of the arms (1,2,3,4,7,8) containing rollers (B, B1) ensures that the hub (6) remains at the center of spherical enclosure (20). When the armature (5) displaces inside the enclosure (20) due to acceleration acting on the object (P), the rollers (B, B1) may ensure smooth, anti-frictional contact of the armature (5) with the inner surface (IS) of the enclosure (20). In an embodiment, the entire enclosure (20) may be accommodated in a transparent housing (30) or a casing, as shown in FIG. 4.

In an embodiment, a roller (B1) attached to at least one arm (1) of the plurality of arms (1,2,3,4,7,8) may be opaque. The roller (B1) may either be manufactured of an opaque material, or may be rendered opaque by processes including but not limited to painting, coating, plating or any other deposition technique. The opaque roller (B1) distinguishes the at least one arm (1) from rest of the arms (2,3,4,7,8), so that the displacement of the at least one arm (1) may be observed and monitored during determination of the acceleration of the object (P).

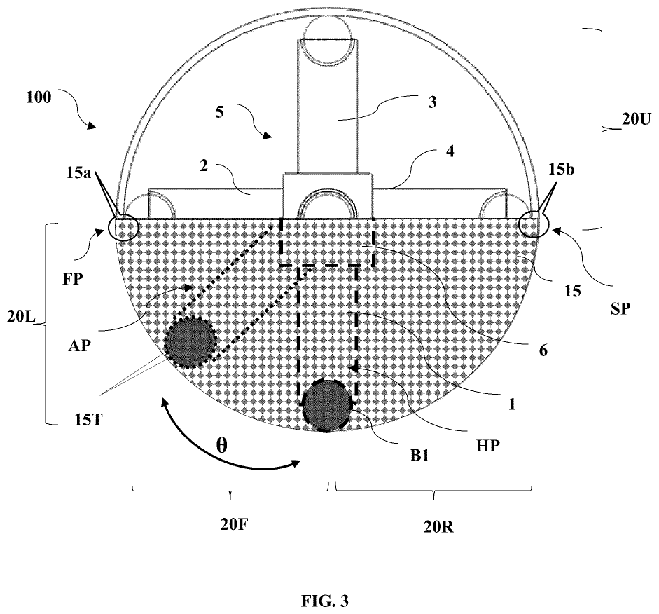

FIG. 3 is an exemplary embodiment illustrating a front sectional view of the accelerometer (100) of the present disclosure embedded with a plurality of sensors (15). Reference is also made to FIGS. 1 and 2. As shown in FIG. 3, the accelerometer (100) may be embedded with a plurality of sensors (15), including, but not limited to optical sensors. In an embodiment, the sensors (15) may be embedded on an outer surface [on a quadrant or an arcuate segment] of lower hemisphere (20L) of the sphere-shaped enclosure (20). In another embodiment, the sensors (15) may be embedded on upper, right or left hemisphere or quadrant surface on the outside of the enclosure (20) depending on which arm carries the opaque roller (B1). When the armature (5) displaces due to an acceleration, each of these hemispheres can contain the at least one arm (1), i.e., the arm (1) [with the opaque roller (B1)] which will displace, thereby blocking light from impinging on a sensor (15T) triggering a signal. This in turn can be read as the acceleration of the accelerometer and/or the object to which it is attached.

The sensors (15) may be placed such that during angular displacement of the at least one arm (1) carrying the opaque roller (B1), visibility of a sensor or a group of sensors (15T) out of the plurality of sensors (15) may be completely blocked/eclipsed by the opacity of the roller (B1) when viewed from the opposite side. For example, if the at least one arm (1) is displaced through an angle ‘0’ to the angular position (AP) [FIG. 3], the sensors (15T) corresponding to the angular position (AP) will completely be blocked/eclipsed by the opaque bearing (B1) when viewed from opposite side i.e., from behind the page in case of front view shown in FIG. 3. Similarly, at the first position (FP) i.e., −90 degree position of the at least one arm (1) [see FIG. 3], a sensor or a group of sensors (15a) will completely be blocked/eclipsed by the opaque bearing (B1) of the at least one arm (1).

The sensor or group of sensors so blocked by the opaque roller (B1) will not receive any light when illuminated from a light source present on the opposite side i.e., a side opposite to the location of the plurality of sensors (15). For example, if the sensors (15) are embedded on the outside of the lower hemispherical surface of the spherical enclosure (20), the light source may be provided vertically above the spherical enclosure (20). Similarly, if the sensors (15) are embedded outside the right hemispherical surface, the light source may be positioned adjacent to the left hemispherical surface to illuminate the sensors (15) with the armature (5) present between said light source and the sensors (15). This results in the sensor or the group of sensors not receiving the light, which in turn triggers a signal, thereby giving an indication that the at least one arm (1) has deflected or displaced to the predefined angular position (AP), which in turn is in proportion to acceleration of the object (P). This signal can be interpreted as the acceleration of the object (P) to which the accelerometer (100) is attached. Thus, displacement of the at least one arm (1) to a unique angular position (AP) gives a measure of a particular acceleration with which the object (P) is accelerated. Accuracy of detection of the deflection/displacement of the at least one arm (1) may be increased by increasing the number of sensors (15) and decreasing the spacing between them. For example, accuracy may be enhanced by positioning a number of miniaturized sensors (15) for every degree or every half a degree of the angular position (AP).

FIG. 4 is another exemplary embodiment illustrating the accelerometer (100) of the present disclosure as placed in a transparent housing (30) and illuminated by a light source (L1) positioned adjacent to i.e., above the enclosure (20). Reference is also made to FIGS. 1-3 with FIG. 4 to describe the method embodiment of the present disclosure. The accelerometer (100) having a sphere-shaped enclosure (20) of diameter ‘D’ may be positioned in contact with the object (P) as depicted in FIG. 1. The light source (L1) may be selected such that the light beam from the light source (L1) has same diameter ‘D’ as that of the sphere-shaped enclosure (20) or a slightly higher diameter than diameter ‘D’ of the sphere-shaped enclosure, depending on the requirement. Optical sensors (15) may be placed on the sphere-shaped enclosure (20) as explained in previous paragraphs, and away [opposite] from the light source (L1). For instance, as shown in FIG. 4, the light source (L1) is positioned above the spherical enclosure (20) and the sensors (15) are embedded on a portion of outside of the lower hemispherical surface (20L), or on the entire lower hemispherical surface (20L). The light beam passes through the armature (5) as explained in previous paragraphs and illuminates the sensors (15) except the sensor or the group of sensors shadowed by the opaque roller (B1), as depicted in FIGS. 1-3. Alternately, the sensors (15) can be embedded on the outside of left, upper, or right hemispherical surfaces, and the position of the light source (L1) may be changed accordingly to illuminate the sensors. Deflection of the at least one arm (1) to a predefined angular position (AP) will block the light of L1 from impinging or falling on a particular sensor or a group of sensors (15T, 15a, 15b) corresponding to the angular position (AP) of the at least one arm (1). The sensor or the group of sensors (15T, 15a, 15b) not receiving any light generates signals and sends the signal as a feedback to an indication or a display device intended to indicate/display the angular position (AP) of the at least one arm (1). In another embodiment, the sensor or group of sensors (15T, 15a, 15b) that are not receiving any light may remain in a deactivated state, while rest of the sensors which get illuminated may send feedback signals about them getting illuminated. The deactivated [darkened or shadowed] state of the sensor or the group of sensors (15T, 15a, 15b) may be used to determine the angular position (AP) of the at least one arm (1) in response to the acceleration of the object (P). In an embodiment, the sphere-shaped enclosure (20) may be mounted on a support, like a pin or an arm, such that zero position of the at least one arm (1) coincides with the pin or the arm on which the enclosure is mounted. Since sensors (15) are distributed over the lower hemisphere (20L) of the sphere-shaped enclosure (20), angular deflection of the at least one arm (1) in any of the three angular directions may be conveniently determined. In another embodiment of the disclosure, the light source (L1) may be embedded at a center of the hub (6) [which is also the center of the enclosure (20)], such that the transparency of the hub (6) and the arms (1,2,3,4,7,8) allow the light to pass through and impinge on the sensors (15). Depending on the acceleration, the at least one arm (1) deflects to the predefined angular position (AP), and the light from the light source at the center of the hub (6) is blocked by the opaque roller (B1) from reaching a sensor or the group of sensors aligning with the predefined angular position (AP) of the arm (1).

An exemplary operational embodiment in which the at least one arm (1) exhibits a two-dimensional angular displacement when the object (P) is accelerated by force (F) is presented with reference to FIG. 1. The at least one arm (1) of the armature (5) exhibits angular oscillation/displacement from its home (original or mean or neutral) position (HP) [coinciding with axis A-A] towards the first position (FP) or the second position (SP). In this case, angular displacement of the at least one arm (1) takes place about axis X-X [see FIG. 2]. In an embodiment, the first and second positions may be −90 degrees and +90 degrees, respectively, which may define the maximum angular displacement positions of the at least one arm (1). In another embodiment, angular deflection in positive direction (SD) i.e., any angle between 0 and +90 degrees, corresponds to one direction [right] of acceleration of the object (P). Similarly, angular deflection towards negative direction (FD) i.e., any angle between 0 and −90 degrees, corresponds to opposite direction [left] of acceleration of the object (P). The angular deflection of +/−90 degrees is an exemplary range only and should not be construed as a limitation, as other angles of rotations, for example, greater than 90 degrees may also be possible. In an embodiment, the home position (HP) may lie between the first position (FP) and the second position (SP). In other words, the home position (HP) may be designated as the zero position [vertical position as shown in FIGS. 1 and 3] which is between and angularly equidistant from the first position [−90 degree position] and the second position [+90 degree position].

The accelerometer of the present disclosure provides a number of advantages. One advantage is the improved sensitivity of the armature due to lightweight construction and presence of rollers [bearings], and benefits in terms of accuracy due to presence of optical sensors. Sensitivity of detection of any movement, i.e., even smallest accelerations can be measured by strategically placing a number of sensors for a given angular range, thereby enhancing accuracy of measurements. Another advantage is that the accelerometer is easy to construct, compact, portable, customizable to different sizes and cost effective. Use of polymeric and composite materials to construct the accelerometer increases durability. Yet another advantage is that the accelerometer can be readily coupled or contacted with any object having any shape or orientation, thereby allowing determination/measurement of acceleration in a quick and reliable manner.

The accelerometer uses fewer complex parts in order to achieve accurate results. This also translates to a much economical overall cost manufacturing of the accelerometer.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

Table of reference numerals:

| Part | Numeral/Symbol |
|---|---|
| Accelerometer | 100 |
| Arms | 1, 2, 3, 4, 7, 8 |
| Armature | 5 |
| Hub | 6 |
| Sensors | 15, 15a, 15b, 15T |
| Enclosure | 20 |
| Wall of the enclosure | 20W |
| Interior volume | 20V |
| Lower, Upper, Right, and left | 20L, 20U, 20R, 20F |
| hemisphere | |
| Housing | 30 |
| Rollers | B, B1 |
| Object | P |
| First position | FP |
| Second position | SP |
| First direction | FD |
| Second direction | SD |
| Object acceleration direction | OAD |
| Diameter of enclosure/light beam | D |
| Light source | L1 |
| Radius of bearing | R |
| Diameter of arms | d |
| Applied force | F |
| Inner surface | IS |
| Home position | HP |
| Angular position | AP |
| Angle of displacement | θ |
| Free end of arm | FE |
| Axes | X-X, Y-Y, A-A |

1. An accelerometer for determining acceleration of an object, the accelerometer comprising:
an enclosure;
an armature movably disposed inside the enclosure, the armature comprising:
a hub; and
a plurality of arms made of lightweight material and extending from the hub, each of the plurality of arms is defined with at least one roller at a free end and configured to contact an inner surface of the enclosure, such that at least one arm of the plurality of arms is defined with an opaque roller;
wherein, the armature is configured to displace within the enclosure about at least one axis in response to acceleration imparted on the object, and displaces the at least one arm of the plurality of arms to a predefined angular position between a first position and a second position;
a plurality of sensors embedded on at least a portion of an outer surface of the enclosure at close proximity;
and
at least one light source positioned adjacent to the enclosure and configured to illuminate the accelerometer,
wherein, the opaque roller is configured to block light from reaching at least one sensor of the plurality of sensors corresponding to the predefined angular position of the at least one arm of the plurality of arms, indicative of the acceleration of the object.

2. The accelerometer as claimed in claim 1, wherein the enclosure contacts the object for determination of the acceleration.

3. The accelerometer as claimed in claim 1, wherein the enclosure is accommodated in a transparent housing.

4. The accelerometer as claimed in claim 1, wherein the plurality of arms includes at least three pairs of arms, each pair of arms protruding from the hub towards the inner surface of the enclosure along a coordinate axis.

5. The accelerometer as claimed in claim 4, wherein each of the pairs of arms extends orthogonally from the hub relative to other pairs of arms.

6. The accelerometer as claimed in claim 1, wherein the enclosure is a transparent enclosure of spherical shape configured to allow passage of light onto the plurality of sensors.

7. The accelerometer as claimed in claim 6, wherein the plurality of sensors is embedded on outside of at least one of a lower hemispherical surface, an upper hemispherical surface, a right hemispherical surface, and a left hemispherical surface of the spherical shaped enclosure.

8. The accelerometer as claimed in claim 1, wherein:
the at least one arm remains at a home position when no acceleration is imparted on the object;
a first position corresponds to −90 degree position of the at least one arm of the plurality of arms; and
a second position corresponds to +90 degree position of the at least one arm of the plurality of arms,
wherein, the home position lies between the first position and the second position.

9. The accelerometer as claimed in claim 1, wherein the enclosure and the rollers are made of a material having low coefficient of friction.

10. A method of determining acceleration of an object, comprising:
positioning the object in contact with an accelerometer, the accelerometer comprising:
an enclosure,
an armature movably disposed inside the enclosure, the armature comprising:
a hub; and
a plurality of arms extending from the hub, each of the plurality of arms defined with at least one roller at a free end and configured to contact an inner surface of the enclosure,
such that at least one arm
(1) of the plurality of arms is defined with an opaque roller;
wherein, the armature is configured to displace within the enclosure about at least one axis in response to acceleration imparted on the object, and displaces the at least
one arm of the plurality of arms to a predefined angular position between a first position and a second position;
and
a plurality of sensors embedded on at least a portion of an outer surface of the enclosure;
positioning at least one light source adjacent to the accelerometer, the at least one light source configured to illuminate the accelerometer, such that the opaque roller is configured to block light from reaching at least one sensor of the plurality of sensors corresponding to the predefined angular position of the at least one arm;
and
receiving a signal from the at least one sensor corresponding to the predefined angular position of the at least one arm, the signal indicative of the acceleration of the object.

11. The method as claimed in claim 10, wherein:
the at least one arm remains at a home position when no acceleration is imparted on the object;
a first position corresponds to −90 degree position of the at least one arm;
and
a second position corresponds to +90 degree position of the at least one arm,
wherein, the home position lies between the first position and the second position.
